(19) United States
(12) Patent Application Publication
(10) Pub. No.: US 2014/0181988 A1
(43) Pub. Date: Jun. 26, 2014

(54) INFORMATION PROCESSING TECHNIQUE FOR DATA HIDING

(71) Applicant: FUJITSU LIMITED, KAWASAKI-SHI (JP)

(72) Inventors: Naoki Umeda, Akashi (JP); Yoshihide Tomiyama, Kobe (JP); Naoya Kanasako, Kobe (JP); Hayato Okada, Ikeda (JP)

(73) Assignee: FUJITSU LIMITED, KAWASAKI-SHI (JP)

(21) Appl. No.: 14/066,038

(22) Filed: Oct. 29, 2013

(30) Foreign Application Priority Data
Dec. 26, 2012 (JP) 2012-283490

(51) Int. Cl. G06F 21/60

(52) U.S. Cl. CPC G06F 21/60
USPC 726/26

(57) ABSTRACT

A disclosed method includes: receiving one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed; determining whether or not processing instructions, which include the one or plural received processing instructions, before outputting satisfy a predetermined condition; upon determining that the processing instructions before outputting satisfy the predetermined condition, outputting the processing instructions before outputting; and upon determining that the processing instructions before outputting do not satisfy the predetermined condition, keeping the processing instructions before outputting.

### CROSS-REFERENCE TO RELATED APPLICATIONS

This application is based upon and claims the benefit of priority of the prior Japanese Patent Application No. 2012-283490, filed on Dec. 26, 2012, the entire contents of which are incorporated herein by reference.

### FIELD

This invention relates to a data hiding technique.

### BACKGROUND

For example, a technique exists in which collected personal information is processed to anonymous information in order not to identify individuals.

Typically, even if the personal information is processed to the anonymous information, the anonymous information is pertinent to personal information when it is possible to identify individuals by collating with other information (this property is called “easy collation” property). However, there is no objective reference concerning whether or not the “easy collation” property exists, and it is difficult to determine whether or not the anonymous information is safely utilized. This “easy collation” property has following viewpoints.

(1) Whether or not an environment is provided where collation with other information is easily possible.
(2) Whether or not a person can be identified as a result of collating with other information.

It is not possible to determine (1) by using only software, because the easy collation property is denied by taking into consideration countermeasures including data management (reference authority, reference range and countermeasure against the leak of information). On the other hand, (2) is also called “individual-identification possibility (i.e. the possibility that individuals are identified)”, and it is possible to generate such safer anonymous information by deleting records having a risk against the identification. Accordingly, even when easily collating with other information and even when information to identify individuals is leaked from other sources, it is impossible to identify the individuals and it is possible to use the anonymous information safely.

For example, a technique exists in which the personal information is processed to the anonymous information by identifying and excluding information linked with identification of the individual by collating with the personal information.

Moreover, a technique exists in which data is processed after verifying the possibility that individuals are identified from duplication of records in the anonymous information itself. This uses a theorem that it is impossible to identify the individual from the anonymous information, because N or more results of collation with the personal information are obtained, when N or more duplicate records exist in the anonymous information.

Specifically, a processing as illustrated in FIG. 1 is performed. The anonymous information as illustrated in the left of FIG. 1 includes 3 records, and when there are two same records or more, the same records can be added to the verified anonymous information as records of “verification OK”, because it is confirmed that there is no possibility that individuals are identified in this case. Therefore, because top two records are the same, the top two records are added to the verified anonymous information. On the other hand, because there is only one record for ABCD, “verification NG” is determined, because there is the possibility that individuals are identified. Then, for example, attribute values B and C included in ABCD are converted to X, and a record for AXXD is added to the verified anonymous information. On the other hand, a record itself for ABCD is discarded. This processing method is effective, when records that have already been stored in one database are processed.

However, there is a problem when making data appropriately collected from various transaction systems anonymous and outputting the anonymous data to another system that uses the anonymous data. Specifically, as illustrated in the left side of FIG. 1, 3 records are firstly collected, and when the aforementioned processing is performed for the 3 records, data as illustrated in the right side of FIG. 1 is outputted to another system. After that, when 3 records as illustrated in the left side of FIG. 2 are newly collected and the aforementioned processing is performed for the 3 new records, the top 2 records are the same and it is confirmed that there is no possibility that individuals are identified, the top 2 records are added to the verified anonymous information as records of the “verification OK”. However, because there is one record for ABCD, there is possibility that individuals are identified, and “verification NG” is determined. Then, attribute values B and C are converted to X, and a record for AXXD are added to the verified anonymous information. Then, a record itself for ABCD is discarded. Thus, the record for ABCD appears twice, however, the record for AXXD is registered twice in the verified anonymous information, because the collection timing is different. Accordingly, information for ABCD is lost, and such loss causes any trouble for the statistical processing in other systems.

In addition, there is a technique that identifies individuals from temporal difference of the anonymous information by using portion of the anonymous information, for which the individuals are identified, when such portion is leaked, and a problem may occur when the verified anonymous information is outputted as it is.

Therefore, a technique for making data anonymous while suppressing the possibility that individuals are identified is desired.

### SUMMARY

An information processing method relating to this invention includes: (A) receiving one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed; (B) determining whether or not processing instructions, which include the one or plural received processing instructions, before outputting satisfy a predetermined condition; (C) upon determining that the processing instructions before outputting satisfy the predetermined condition, outputting the processing instructions before outputting; and (D) upon determining that the processing instructions before outputting do not satisfy the predetermined condition, keeping the processing instructions before outputting.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a conventional technique;

FIG. 2 is a diagram to explain the conventional technique;

FIG. 3 is a diagram to explain a basic anonymizing processing relating to a first embodiment;

FIG. 4 is a diagram to explain a basic anonymizing processing relating to the first embodiment;

FIG. 5 is a diagram to explain a basic anonymizing processing relating to the first embodiment;

FIG. 6 is a diagram to explain a basic anonymizing processing relating to the first embodiment;

FIG. 7 is a diagram to explain the possibility that the individuals are identified by data updating using temporal difference;

FIG. 8 is a diagram to explain the possibility that the individuals are identified by the data updating using the temporal difference;

FIG. 9A is a diagram to explain the possibility that the individuals are identified by the data updating using the temporal difference;

FIG. 9B is a diagram to explain the possibility that the individuals are identified by the data updating using the temporal difference;

FIG. 9C is a diagram to explain the possibility that the individuals are identified by the data updating using the temporal difference;

FIG. 10 is a diagram depicting a system configuration example relating to the embodiments;

FIG. 11 is a functional block diagram of an information processing apparatus;

FIG. 12 is a diagram depicting a configuration example of a processing instruction controller and data storage unit, which relate to the first embodiment;

FIG. 13 is a diagram depicting a main processing flow relating to the embodiments;

FIG. 14 is a diagram depicting an example of collected data;

FIG. 15 is a diagram depicting an example of data stored in a definition data storage unit;

FIG. 16 is a diagram depicting an example of a result of data conversion;

FIG. 17 is a diagram depicting an example of a processing instruction that is to be outputted to the processing instruction controller;

FIG. 18 is a diagram depicting an example of a record kept by the anonymizing processing unit;

FIG. 19 is a diagram to explain a processing of the anonymizing processing unit;

FIG. 20 is a diagram depicting an example of data that is to be outputted to the processing instruction controller from the anonymizing processing unit;

FIG. 21 is a diagram depicting a processing flow of an instruction control processing relating to the first embodiment;

FIG. 22 is a diagram depicting an example of data stored in a record management table;

FIG. 23 is a diagram depicting an example of data stored in a target system;

FIG. 24 is a diagram depicting an example of data that is next outputted to the processing instruction controller from the anonymizing processing unit;

FIG. 25 is a diagram depicting an example of data that is next stored in the record management table;

FIG. 26 is a diagram depicting an example of data that is further next outputted to the processing instruction controller from the anonymizing processing unit;

FIG. 27 is a diagram depicting a next state of the data stored in the record management table;

FIG. 28 is a diagram depicting an example of data kept by the target system;

FIG. 29 is a diagram depicting a configuration example of the processing instruction controller and data storage unit, which relate to a second embodiment;

FIG. 30 is a diagram depicting a processing flow of an instruction control processing relating to the second embodiment;

FIG. 31 is a diagram depicting a configuration example of the processing instruction controller and data storage unit, which relate to a third embodiment;

FIG. 32 is a diagram depicting a processing flow of the instruction control processing relating to the third embodiment; and

FIG. 33 is a functional block diagram of a computer.

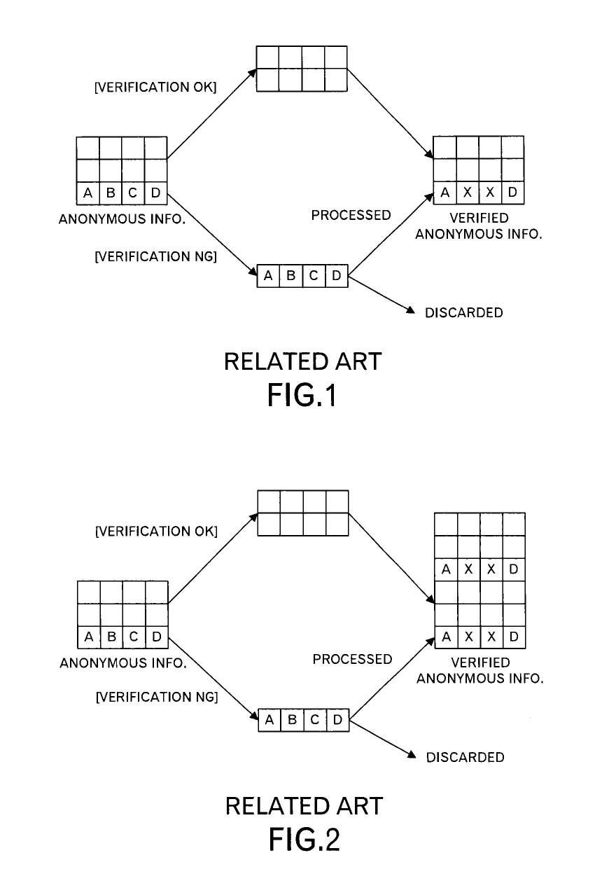

### DESCRIPTION OF EMBODIMENTS

### Embodiment 1

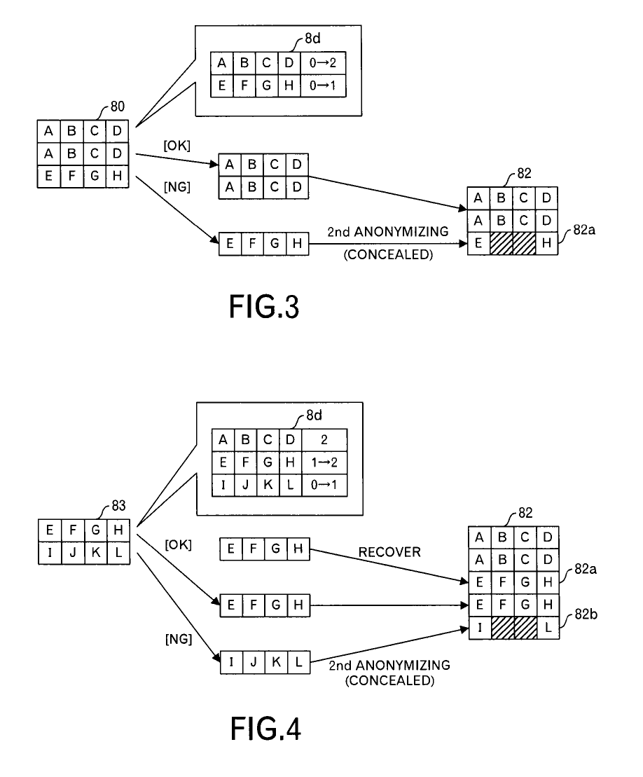

An outline of a processing in a first embodiment will be explained by using FIGS. 3 to 9C. An information processing apparatus that performs a processing in this embodiment collects data from one or plural transaction systems (also called “source system”), makes the collected data anonymous and performs a processing that will be explained later, and then makes it possible to deliver the processed data to another system (also called “target system”) that utilizes the anonymous information.

Firstly, after explaining a basic anonymizing processing, a problem of the possibility that individuals are identified will be explained, and a method for solving the problem of the possibility that individuals are identified will then be explained.

(a) Basic Anonymizing Processing

For example, when collecting three records, the information processing apparatus anonymizes the collected records, and generates anonymized data 80 as illustrated in FIG. 3. Here, the anonymized data 80 is data for which a data conversion processing for the anonymization was performed, and is data that an attribute value is converted to a corresponding value range or parts of attributes in the record are discarded. In an example of FIG. 3, the anonymized data 80 has two records including attribute values “ABCD” and one record including attribute values “EFGH”.

Then, the information processing apparatus counts the number of duplicate records in the anonymized data 80. Next, the information processing apparatus registers the counted result into a duplication management table (TBL) 8d for storing the number of duplicated records, which is held in the information processing apparatus. In the following, a “table” may be abbreviated as “TBL”. As illustrated in an example of FIG. 3, the information processing apparatus registers the number of duplicate records “2” including attribute values “ABCD” into the duplication management table 8d. Moreover, the information processing apparatus registers the number of duplicate records “1” including attribute values “EFGH” into the duplication management table 8d.

Next, the information processing apparatus verifies, for each record in the anonymized data 80, whether or not the record is a record which has a high possibility that the individual is identified. For example, as illustrated in the example of FIG. 3, the information processing apparatus refers to the duplication management table 8d to determines, for each record, whether or not the number of duplicate records is equal to or greater than N (N is a positive integer). In the following, a case where the value of N is “2” will be explained. The information processing apparatus determines that two records that include the attribute values “ABCD” and whose number of duplicate records is equal to or greater than N are “OK”, in other words, that the possibility that the individual is identified is low, and delivers the two records as additional records to the target system without second anonymizing.

On the other hand, the information processing apparatus determines that one record that includes attribute values “EFGH” and whose number of duplicate records is less than N is “NG”, in other words, that the possibility that the individual is identified is high, and delivers the record to the target system as the additional record after second anonymizing. As a result, as illustrated in an example of FIG. 3, the verified anonymized data 82 is delivered. As illustrated in the example of FIG. 3, the verified anonymized data 82 includes, as a result of the second anonymizing, a record 82a whose attribute values “FG” is discarded (also called “concealed”) from the attribute values “EFGH”.

Then, when the information processing apparatus newly collects two records from the source system, the information processing apparatus anonymizes the collected records to generate the anonymized data 83 as illustrated in an example of FIG. 4. In the example of FIG. 4, the anonymized data 83 includes one record including the attribute values “EFGH” and one record including the attribute values “IJKL”.

Then, the information processing apparatus counts the number of duplicate records in the anonymized data 83. Next, the information processing apparatus reflects the counted result to the duplication management table 8d. In other words, as illustrated in the example of FIG. 4, the information processing apparatus updates the number of duplicate records including the attribute values “EFGH” in the duplication management table 8d from “1” to “2”, and registers “1” as the number of duplicate records including the attribute values “IJKL”.

Next, the information processing apparatus verifies, for each record in the anonymized data 83, whether or not the record is a record having a high possibility that the individual is identified. For example, as illustrated in the example of FIG. 4, the information processing apparatus refers to the duplication management table 8d to determine, for each record, whether or not the number of duplicate records is equal to or greater than N. The information processing apparatus determines that the record that includes attribute values “EFGH” and whose number of duplicate records is equal to or greater than N is OK, and delivers the record to the target system as the additional record without second anonymizing. Moreover, because the possibility that the individual is identified for the record 82a that includes attribute values “EXXH” (XX represent concealed attribute values) becomes low, the information processing apparatus outputs a recovery instruction to the target system so as to cancel (or recover) the second anonymization of the record 82a. Thus, as illustrated in FIG. 4, the target system registers the concealed attribute values FG in the record 82a.

Because the information processing apparatus performs the aforementioned processing, it is possible to suppress an amount of data for which it is determined that a predetermined condition “data is identical” between data is not satisfied among data included in the collected data. As a result, a lot of records are effectively utilized when a predetermined processing such as a statistical processing is performed in the target system. Moreover, there is a case that portions may be concealed, however, when new records are obtained, records are immediately added to the target system. Therefore, the immediacy is excellent.

On the other hand, the information processing apparatus determines that the record “IJKL” whose number of duplicate records is less than N is “NG”, in other words, there is a high possibility that the individual is identified, and after second anonymizing (i.e. concealing), the record is delivered to the target system as an additional record. As a result, the verified anonymized data 82 as illustrated in the example of FIG. 4 is stored. As illustrated in the example of FIG. 4, the verified anonymized data 82 includes a record 82b in which the attribute values JL is concealed from the attribute values IJKL as the result of the second anonymizing.

Here, the source system updates or deletes data stored in its own database in response to instructions from the user or the like. For example, when an instruction to update a record including attribute values efgh to a record including attribute values abcd is accepted from the user, the source system performs a following processing. In other words, the source system updates the record that includes the attribute values efgh and is stored in its own database to the record including the attribute values abcd. In such a case, the record including the attribute values efgh is anonymized to the record including the attribute values EFGH in the anonymized data 80 illustrated in the example of FIG. 3. Moreover, the record including the attribute value abcd is anonymized to the record including the attribute values ABCD. Then, the source system transmits update data representing the record including the attribute values efgh is updated to the record including the attribute values abcd to the information processing apparatus.

When the information processing apparatus receives the update data representing that the record including the attribute values efgh is updated to the record including the attribute values abcd, a following processing is carried out. In other words, the information processing apparatus outputs a processing instruction to update the delivered record based on the update represented by the received update data to the target system. Here, the updated data received by the information processing apparatus means that updating the stored record including the attribute values EFGH to the record including the attribute values ABCD.

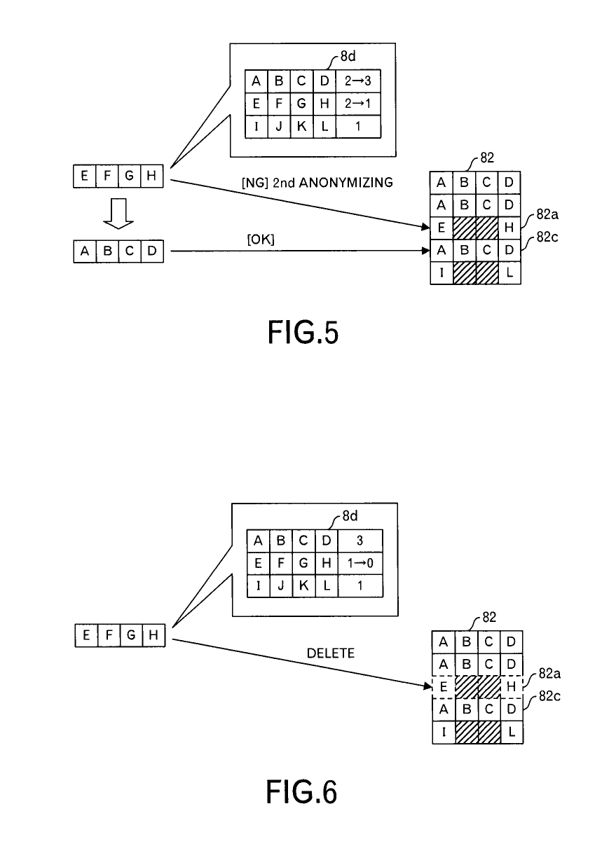

In other words, the update data received by the information processing apparatus means that one record including the attribute values EFGH is deleted and one record including the attribute values ABCD is added. Thus, as illustrated in an example of FIG. 5, the information processing apparatus that received the update data updates the number of duplicate records including the attribute values EFGH in the duplication management table 8d from “2” to “1”, and updates the number of duplicate records including the attribute values ABCD from “2” to “3”.

Then, as illustrated in the example of FIG. 5, the information processing apparatus refers to the duplication management table 8d to determines whether or not each of the number of duplicate records including the attribute values EFGH before updating and the number of duplicate records including the attribute values ABCD after updating is equal to or greater than N. Then, the information processing apparatus determines that the record that includes the attribute values ABCD is “OK”, because the number of duplicate records is equal to or greater than N, and delivers a processing instruction to update the record including the attribute values EFGH to the record including the attribute values ABCD to the target system. Thus, as illustrated in FIG. 5, the target system updates the record 82c including the attribute values EFGH and included in the verified anonymized data 82 to the record including the attribute values ABCD.

Moreover, the information processing apparatus determines that one record including the EFGH is “NG”, because the number of duplicate records is less than N. Here, as for one record including the attribute values EFGH, the number of duplicate records becomes “N−1” from “N” according to the present update. In other words, the record 82a including the attribute values EFGH becomes a record for which the second anonymizing (i.e. concealing) is not performed, and the possibility that the individual is identified becomes high with the present update. Therefore, the second anonymizing is performed for one record including the attribute values EFGH, because the number of duplicate records is less than N. Then, the information processing apparatus transmits a processing instruction to conceal the attribute values FG from the attribute values EFGH in the record including the attribute values EFGH to the target system. With this processing, as illustrated in FIG. 5, the target system updates the record 82a to the record in which the attribute values FG in the attribute values EFGH is concealed by performing the second anonymizing.

Thus, when the information processing apparatus receives the update data that is information relating to the update, the information processing apparatus determines whether or not the number of duplicate records that correspond to a record before the update or after the update is equal to or greater than N, and performs a processing such as the concealing, recovering and adding according to the determination result. Thus, the information processing apparatus can update the data stored in the target system in response to receipt of the update data.

When the information processing apparatus receives the update data representing that the record including the attribute values efgh was deleted, the information processing apparatus performs a following processing. In other words, the information processing apparatus outputs a processing instruction to update the delivered record based on the update represented by the received update data to the target system.

Therefore, the update data received by the information processing apparatus means that one record including the attribute values EFGH is deleted. Thus, as illustrated in an example of FIG. 6, the information processing apparatus that received the update data updates the number of duplicate records including the attribute values EFGH in the duplication management table 8d from “1” to “0”.

Then, as illustrated in an example of FIG. 6, the information processing apparatus refers to the duplication management table 8d to determine, for the record including the attribute values EFGH before deleting, whether or not the number of duplicate records becomes N−1. In such a case, because the number of duplicate records has already become less than N, this condition is not satisfied. Therefore, the information processing apparatus outputs a processing instruction to delete the record including the attribute values EXXH to the target system. With this processing, as illustrated by a dotted line in FIG. 6, the target system deletes the record 82a.

On the other hand, when the number of duplicate records becomes N−1 in case where a record that is deleted in response to receipt of an instruction to delete a record is deleted, the information processing apparatus outputs a processing instruction to conceal the record having the same attribute values to the target system. With this processing, it is possible to keep the level of the anonymizing. When the number of duplicate records is equal to or greater than N even if the record to be deleted is actually deleted, the information processing apparatus outputs a processing instruction to simply delete the designated record, to the target system. The target system updates the saved records according to the processing instruction from the information processing apparatus.

(b) Possibility that Individuals are Identified

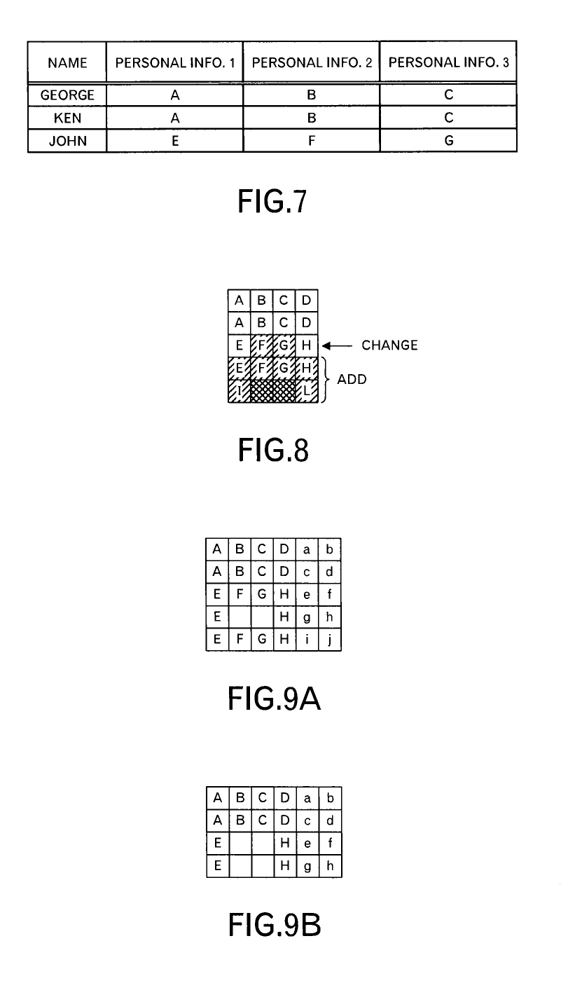

For example, in a state that the anonymized data 82 illustrated in FIG. 3 is generated, when the anonymized data in which individuals are identified as illustrated in FIG. 7 is leaked, there is a case where an individual is identified from the temporal difference with the anonymized data 82 illustrated in FIG. 4. More specifically, a hatched portion illustrated in FIG. 8 represents the temporal difference, however, the two lowest records are newly added records, so even if a portion of the attribute values in the anonymized data 82 illustrated in FIG. 3 is concealed, it can be understood that the third record is for the name “John”. Here, the sensitive information is omitted in figure, however, the record includes the sensitive information. Therefore, the sensitive information for which the individual is identified is leaked entirely to outside.

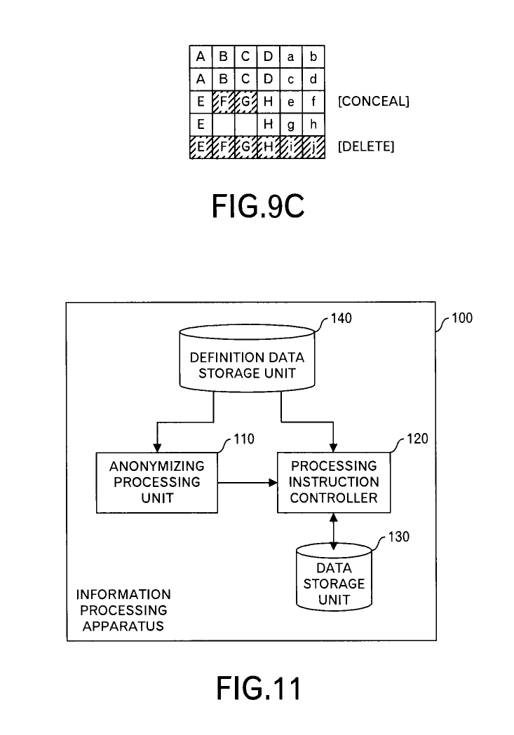

In addition, after anonymized data as illustrated in FIG. 9A is generated as another example, anonymized data as illustrated in FIG. 9B is generated when the fifth record is deleted. The two right columns represent the sensitive information, and other portions represent anonymized personal information. Moreover, as for the third record in FIG. 9A, the number of duplicate records becomes N−1 (i.e. “1”). Therefore, FG is concealed in the anonymized data in FIG. 9B. Here, the temporal difference between FIG. 9A and FIG. 9B is depicted in FIG. 9C. The hatched portion in FIG. 9C is the temporal difference. On the other hand, when the anonymized data for which the individuals are identified as illustrated in FIG. 7 is leaked at a timing when the anonymized data in FIG. 9B is generated, it can be understood that the third record for which the concealment was performed is for the name “John”. More specifically, when it is possible to obtain the leaked data as illustrated in FIG. 7 at a timing when the anonymized data in FIG. 9B is generated, the fifth record in FIG. 9C is not included in the anonymized data in FIG. 9B. Therefore, only the third record for which the concealment was performed corresponds to the record whose name is “John”.

(c) Scheme in this Embodiment

As for the basic anonymizing processing in this embodiment, no problem occurs if the leak of data does not occur. However, in case where the leak of data occurs, when the processing instruction “conceal” or “recover”, which particularly affects the possibility that the individuals are identified is immediately executed, the possibility that the individuals are identified increases by the data analysis using the temporal difference. Therefore, in this embodiment, by performing the following processing to appropriately control the execution timing of the processing instruction, it is possible to suppress the possibility that the individuals are identified. Especially, in this embodiment, the execution timing of the processing instructions for the records including a specific record for which a processing instruction “conceal” or “recover” was executed is delayed until another processing instruction such as updating or deleting for the specific record is received.

In the following, a system and processing contents to perform the aforementioned processing will be explained.

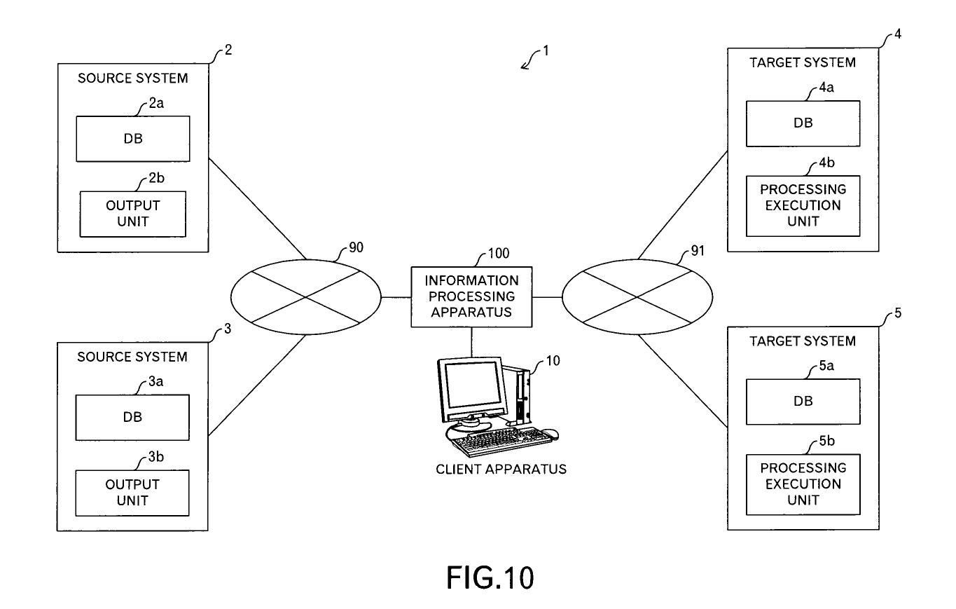

A system 1 illustrated in an example of FIG. 10 has source systems 2 and 3, an information processing apparatus 100 and target systems 4 and 5. The number of source systems 2 and 3 and the number of target systems 4 and 5 are not limited to “2”, and may be arbitrary number that is equal to or greater than 1. Moreover, the source systems 2 and 3 are connected through a network 90 with the information processing apparatus 100, and the information processing apparatus 100 is connected through a network 91 with the target systems 4 and 5. In addition, the information processing apparatus 100 is connected to a client apparatus 10, which is operated by an administrator or the like through an arbitrary wired or wireless communication network.

The source system 2 has a database (DB) 2a and an output unit 2b, and when an addition, deletion or update of a record occurs for the DB 2a, the output unit 2b transmits data for the record updated or the like through the network 90 to the information processing apparatus 100. Similarly, the source system 3 has a DB 3a and an output unit 3b, and when an addition, deletion or update of a record occurs for the DB 3a, the output unit 3b transmits data for the record updated or the like through the network 90 to the information processing apparatus 100.

Moreover, the target system 4 has a DB 4a and a processing execution unit 4b, and when a processing instruction is received from the information processing apparatus 100 through the network 91, the processing execution unit 4b executes the processing instruction for the DB 4a. Moreover, the target system 5 has a DB 5a and a processing execution unit 5b, and when a processing instruction is received from the information processing apparatus 100 through the network 91, the processing execution unit 5b executes the processing instruction for the DB 5a.

The client apparatus 10 outputs setting data such as a threshold N of the number of duplicate records or the like, which is accepted from the administrator or the like, to the information processing apparatus 100.

Next, a functional block diagram of the information processing apparatus 100 is illustrated in FIG. 11. The information processing apparatus 100 relating to this embodiment has an anonymizing processing unit 110, a processing instruction controller 120, a data storage unit 130 and a definition data storage unit 140.

The definition data storage unit 140 stores setting data and the like, which are inputted by the client apparatus 10 and used by the anonymizing processing unit 110 and processing instruction controller 120.

The anonymizing processing unit 110 performs a basic anonymizing processing described above in (a). Then, the anonymizing processing unit 110 outputs a processing instruction including a processing result of the anonymizing processing and a processing content for causing the processing result to be reflected to the processing instruction controller 120. The processing instruction controller 120 temporarily stores the processing instruction into the data storage unit 130, and then determines an output timing of the processing instruction, and outputs the processing instruction at an appropriate timing to the target systems 4 and 5.

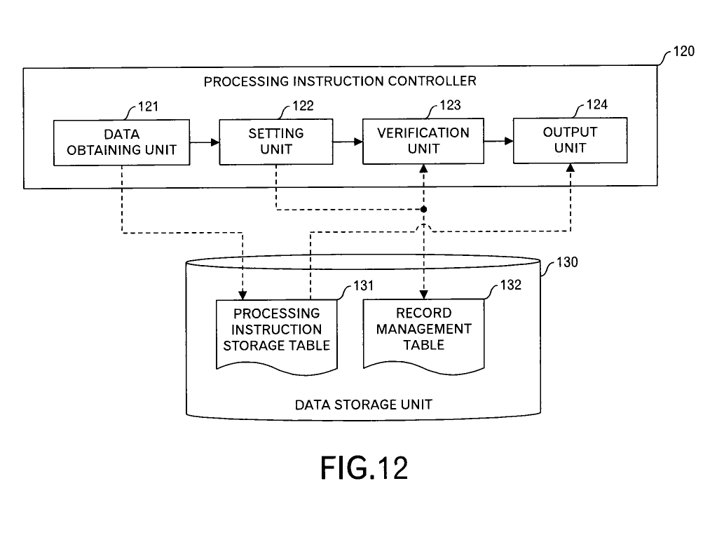

FIG. 12 illustrates a configuration example of the processing instruction controller 120 and data storage unit 130. The processing instruction controller 120 has a data obtaining unit 121, setting unit 122, verification unit 123 and output unit 124. Moreover, the data storage unit 130 stores a processing instruction storage table 131 and a record management table 132.

When receiving the processing instruction from the anonymizing processing unit 110, the data obtaining unit 121 stores the processing instruction into the processing instruction storage table 131, and outputs the processing instruction to the setting unit 122. When receiving the processing instruction, the setting unit 122 performs a setting for the record management table 132, and instructs the verification unit 123 to perform the processing. The verification unit 123 verifies whether or not the processing instruction stored in the processing instruction storage table 131 may be outputted, according to the record management table 132. When the verification unit 123 determines that the processing instruction stored in the processing instruction storage table 131 cannot be outputted, the verification unit 123 performs no processing, however, when it is determined that the processing instruction can be outputted, the verification unit 123 outputs an output instruction to the output unit 124. The output unit 124 outputs the processing instruction stored in the processing instruction storage table 131 to the target systems 4 and 5 in response to the output instruction from the verification unit 123.

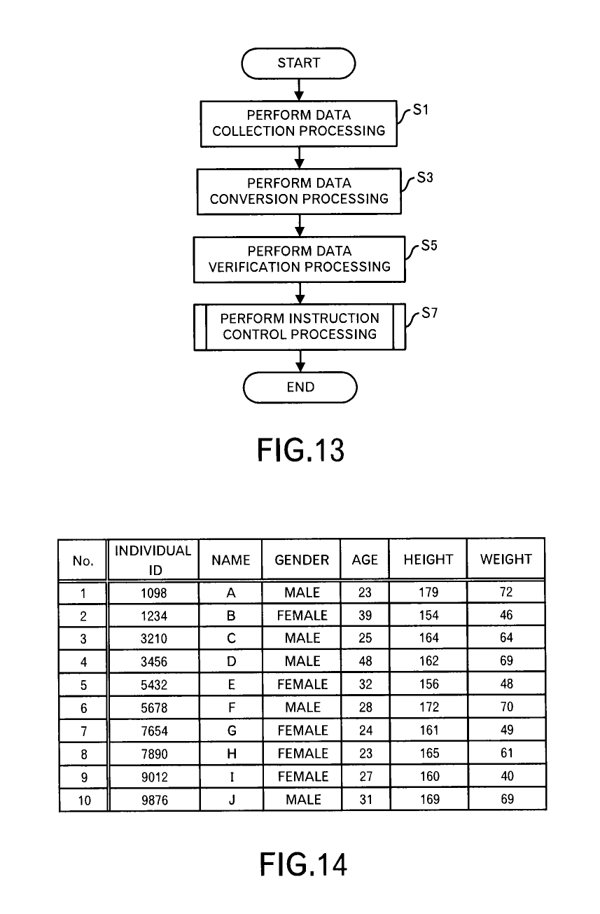

Next, processing contents of the information processing apparatus 100 will be explained by using FIGS. 13 to 28. First, the anonymizing processing unit 110 performs a data collection processing to collect data from the source system 2 or 3 (FIG. 13: step S1). For example, data as illustrated in FIG. 14 is collected. In an example of FIG. 14, each record includes an individual identifier (ID), name, gender, age, height and weight. The number (No.) is added for convenience in order to make it easy to identify the record in later the explanation of this processing, however, the number is not included actually.

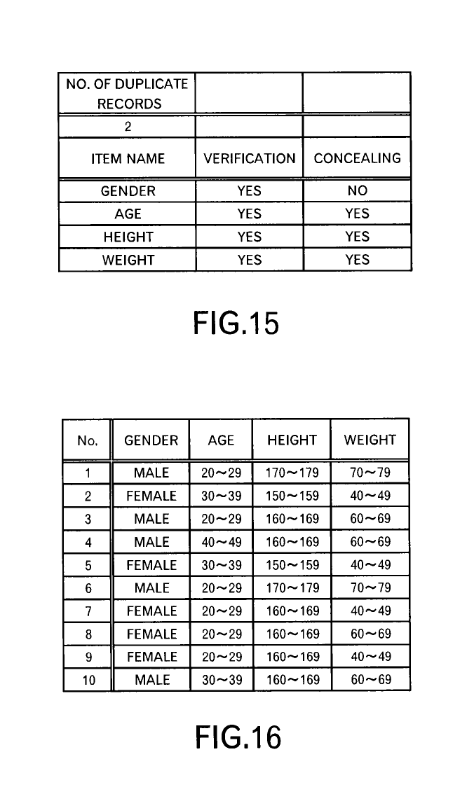

Moreover, the anonymizing processing unit 110 performs a predetermined data conversion processing according to data stored in the definition data storage unit 140 (step S3). An example of the definition data stored in the definition data storage unit 140 is illustrated in FIG. 15. In the example of FIG. 15, the number of duplicate records, which is a determination reference of the anonymizing, data representing whether or not the verification is to be performed for each item, and data representing whether or not the concealing is to be performed for each item. In the example of FIG. 15, “gender”, “age”, “height” and “weight” are listed as items, and data for other items in the personal information is discarded for the anonymizing. More specifically, the “individual ID” and “name” are discarded. In this embodiment, as for items designated as targets of the verification, as one example of anonymizing, it is determined to which value range the value of the item belong among predetermined value ranges, and the value is replaced with data to identify the value range. Then, data illustrated in FIG. 14 is converted to data illustrated in FIG. 16. The sensitive information is omitted both in FIGS. 14 and 16.

After that, the anonymizing processing unit 110 performs a data verification processing for the processing result of the data conversion processing (step S5). This data verification processing is a processing that is other than the data conversion and was explained in FIGS. 3 to 6.

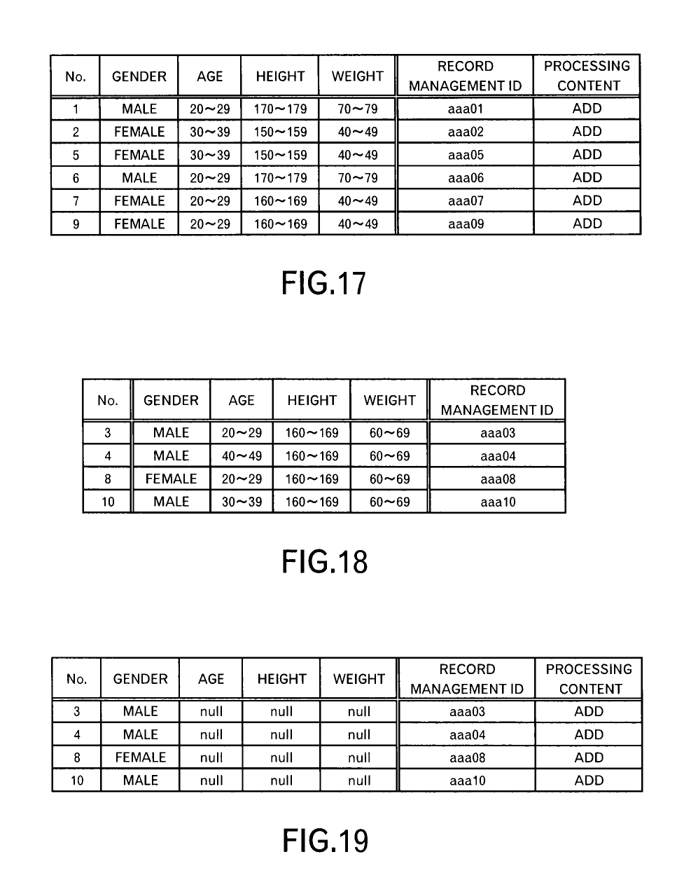

When data illustrated in FIG. 16 is firstly processed, the number of duplicate records is equal to or greater than “2” for the records whose record number is “1”, “2”, “5”, “6”, “7” and “9”. Therefore, a processing “add” is performed for these records as they are. Therefore, as illustrated in FIG. 17, a record management ID and processing content “add” are set for each of these records. Because the processing content is included, these are handled as the processing instruction.

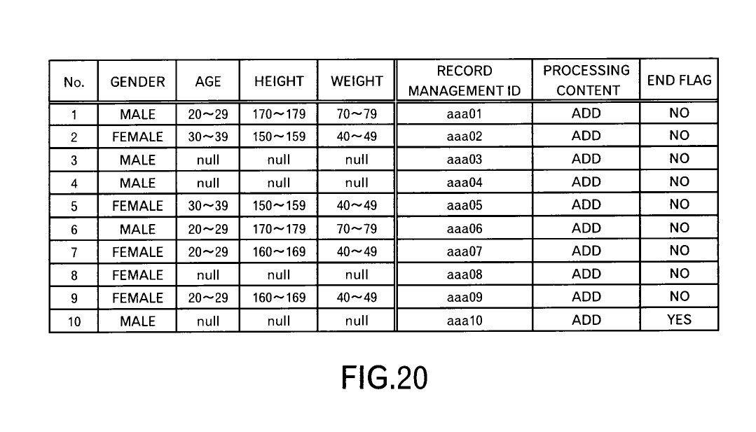

Furthermore, as for the records whose record numbers are “3”, “4”, “8” and “10”, the number of duplicate records is less than “2”, these records are saved after assigning record management IDs as illustrated in FIG. 18 for the later processing. Furthermore, as for records whose record numbers are “3”, “4”, “8” and “10”, the second anonymizing processing, in other words, concealing, is performed, and the same record management ID as in FIG. 18 is assigned, and the processing content “add” is further added. In other words, the processing instructions as illustrated in FIG. 19 are obtained. As a result, the processing instructions as illustrated in FIG. 20 are generated. In an example of FIG. 20, in addition to processing instructions in FIGS. 17 and 19, end flags are assigned. The end flag is a flag enabling to determine whether or not this processing instruction is the final processing instruction among the processing instructions that are current processing targets, and “YES” is set only for the end flag of the record whose record number is “10”.

After that, the anonymizing processing unit 110 outputs the processing instructions as illustrated in FIG. 20 to the processing instruction controller 120.

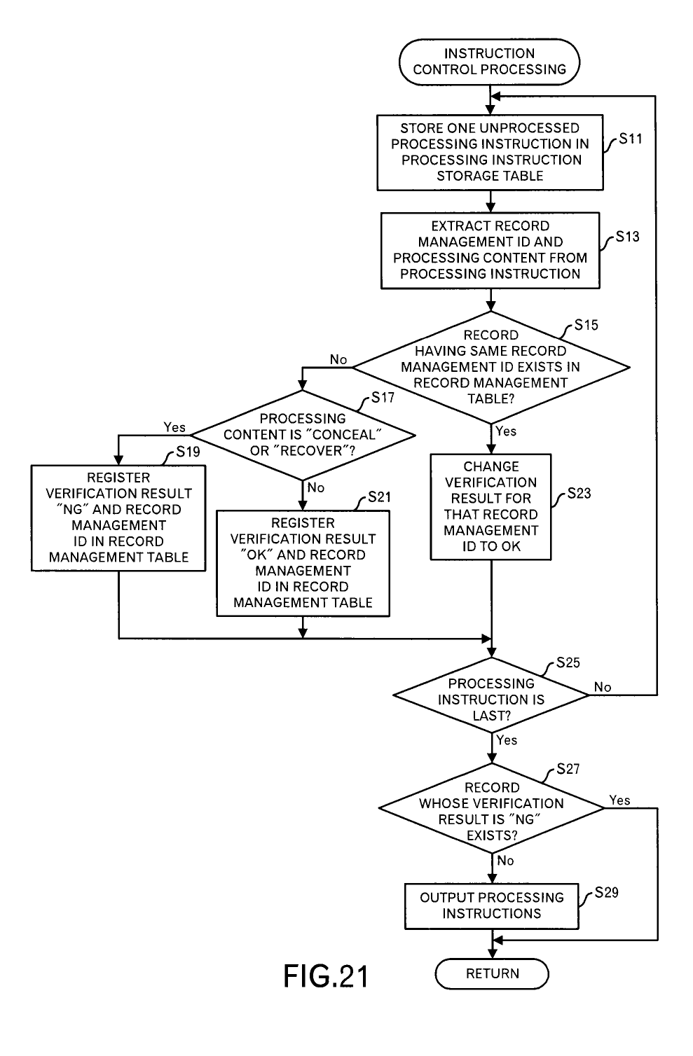

The processing instruction controller 120 performs an instruction control processing for processing instructions received from the anonymizing processing unit 110 (step S7). The instruction control processing will be explained by using FIGS. 21 to 28. The processing ends when the step S7 is executed.

The data obtaining unit 121 of the processing instruction controller 120 stores one unprocessed processing instruction among processing instructions received from the anonymizing processing unit 110 into the processing instruction storage table 131 in the data storage unit 130 (FIG. 21: step S11). More specifically, a processing instruction is selected from the top in sequence. In addition, the data obtaining unit 121 outputs the selected processing instruction to the setting unit 122.

The setting unit 122 extracts the record management ID and processing content from the processing instruction being processed (step S13), and determines whether or not a record having the same record management ID as the extracted record management ID is registered in the record management table 132 in the data storage unit 130 (step S15). When the record is firstly added, there is no case where data having the same record management ID as the extracted record management ID has been registered in the record management table 132.

When data having the same record management ID as the extracted record management ID has not been registered (step S15: No route), the setting unit 122 determines whether or not the extracted processing content is “conceal” or “recover” (step S17). In case where only these operations are performed, it is understood that the possibility that the individuals are identified becomes high when the temporal difference is made. Therefore, this viewpoint is confirmed here. When the extracted processing content is “conceal” or “recover”, the setting unit 122 stores the verification result “NG” and the extracted record management ID in the record management table 132 (step S19). Then, the processing shifts to step S25. On the other hand, when the extracted processing content is not “conceal” or “recover”, the setting unit 122 stores the verification result “OK” and the record management ID in the record management table 132 (step S21). Then, the processing shifts to the step S25.

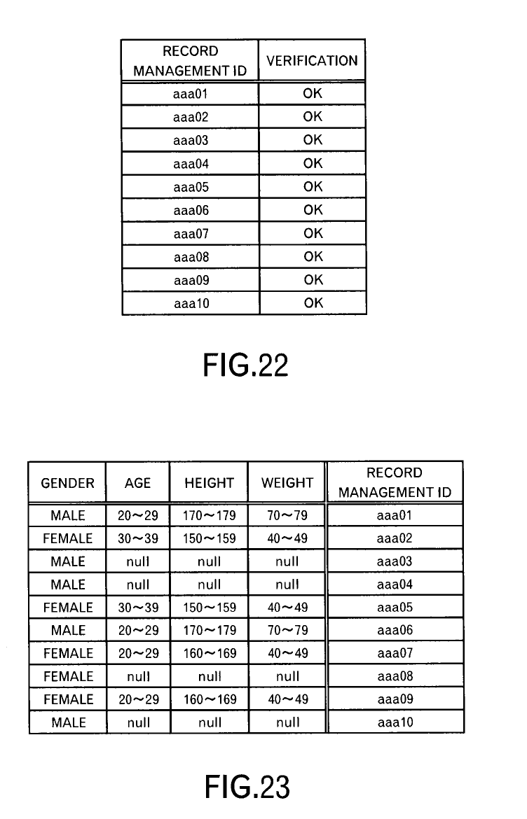

For example, as for the processing instructions as illustrated in FIG. 20, the record management table 132 as illustrated in FIG. 22 is obtained after all of the processing instructions are processed through the step S21.

On the other hand, when data having the same record management ID as the extracted record management ID has been registered in the record management table 132 (step S15: Yes route), three cases are applicable in other words, a first case where the “concealed” or “recovered” record is “updated” or “deleted”, a second case where the “concealed” record is “recovered” and third case where the “recovered” record is “concealed”. These three cases are cases that there is no problem even if the temporal difference is calculated. Therefore, the setting unit 122 changes the verification result of the extracted record management ID to “OK” in the record management table 132 (step S23). Then, the processing shifts to the step S25.

Then, the setting unit 122 determines whether or not the processing instruction is the last processing instruction among the obtained processing instructions, in other words, the end flag of the processing instruction relating to the processing represents “YES” (step S25). When the end flag of the processing instruction is “NO”, the processing returns to the step S11.

On the other hand, when the end flag of the processing instruction relating to the processing is “YES”, the setting unit 122 instructs the verification unit 123 to perform the processing. The verification unit 123 determines whether or not there is a record whose verification result is NG in the record management table 132 in the data storage unit 130 (step S27). When there is even one record whose verification result is NG, the possibility that the individuals are identified becomes high when the temporal difference is calculated. Therefore, the processing instructions stored in the processing instruction storage table 131 are not outputted to the target systems 4 and 5.

On the other hand, when there is no record whose verification result is NG, the verification unit 123 instructs the output unit 124 to perform the processing. The verification unit 123 clears data stored in the record management table 132 at this stage. The output unit 124 reads the processing instructions stored in the processing instruction storage table 131, and outputs the read processing instructions to the target systems 4 and 5 (step S29).

The processing execution units 4b and 5b in the target systems 4 and 5 perform the processing instructions received from the information processing apparatus 100 for the DBs 4a and 5a in sequence. Then, in the example of FIG. 20, data as illustrated in FIG. 23 is stored in the DBs 4a and 5a. Even in FIG. 23, the sensitive information is omitted.

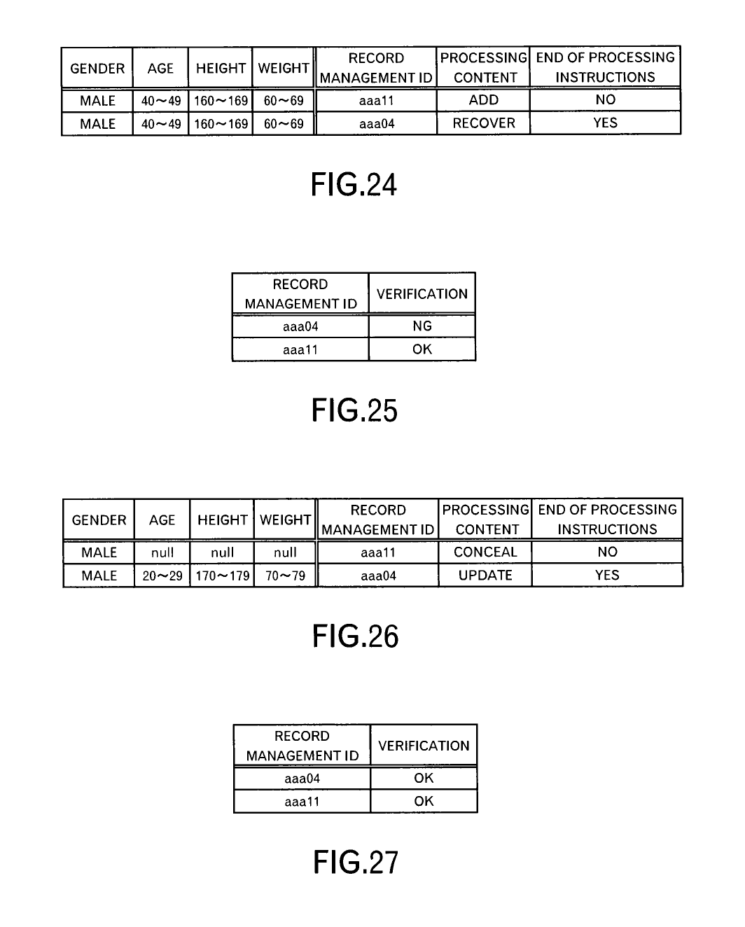

Next, it is assumed that the processing instruction controller 120 receives the processing instructions as illustrated in FIG. 24. This represents a case where, by adding the record whose record management ID is “aaa11”, a record whose record management ID is “aaa04” is recovered.

When the processing flow illustrated in FIG. 21 is performed for these processing instructions, the record management table 132 as illustrated in FIG. 25 is obtained. In other words, because the processing content for the record whose record management ID is “aaa04” is “recover”, the verification result becomes “NG”, and because the processing content for the record whose record management ID is “aaa11” is “add”, the verification result is “OK”. Then, because the possibility that the individuals are identified is heightened by the temporal difference, these processing instructions are not outputted.

Next, it is assumed that the processing instruction controller 120 receives the processing instructions as illustrated in FIG. 26. This represents that the record whose record management ID is “aaa11” is concealed, because the age, height and weight in the record whose record management ID is “aaa04” are updated and the number of duplicate records becomes less than N.

When the processing flow illustrated in FIG. 21 is performed for these processing instructions, the record management table 132 as illustrated in FIG. 27 is obtained. In other words, because the verification results for records of any record management ID become “OK”, the processing instructions illustrated in FIGS. 24 and 26 are outputted to the target systems 4 and 5.

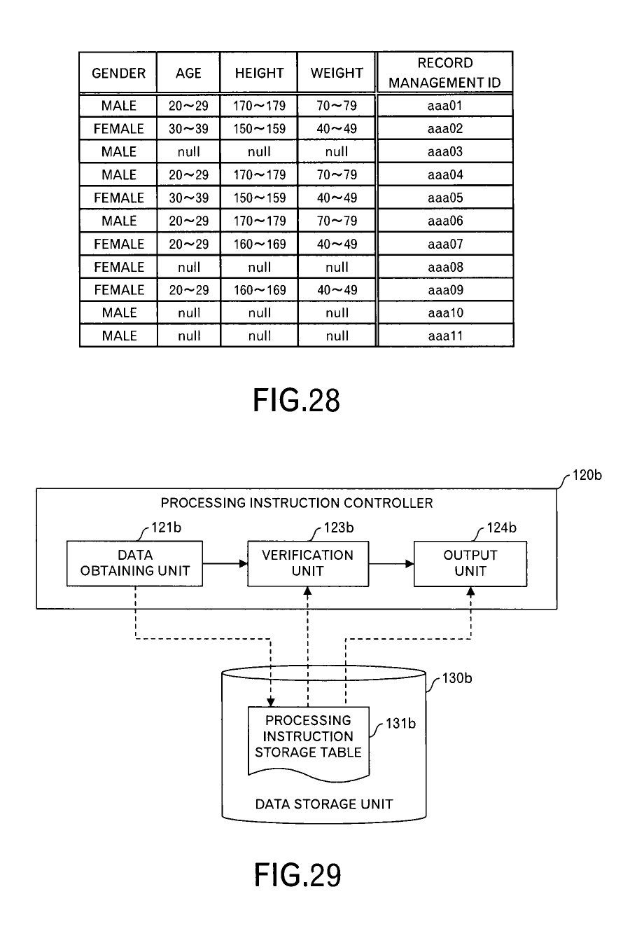

As a result, data as illustrated in FIG. 28 are stored in the DBs 4b and 5b in the target systems 4 and 5. In an example of FIG. 28, the record whose record management ID is “aaa04” is updated, and the record whose record management ID is “aaa11” is added in a concealed state.

By carrying out such a processing, it is possible to securely perform the anonymizing processing and to suppress the possibility that the individuals are identified even when the data analysis is performed by the temporal difference.

### Embodiment 2

In the first embodiment, unless the processing instruction for the concealed or recovered records is outputted again, the processing instructions including that processing instruction are not outputted to the target systems 4 and 5. Therefore, a case that data updating is not easily performed may occur. Then, an embodiment that a priority is given to the immediacy while suppressing the possibility that the individuals are identified as much as possible will be explained.

FIG. 29 illustrates a configuration example of a processing instruction controller 120b and data storage unit 130b, which relate to this embodiment.

The processing instruction controller 120b has a data obtaining unit 121b, a verification unit 123b and an output unit 124b. Moreover, the data storage unit 130b stores the processing instruction storage table 131b.

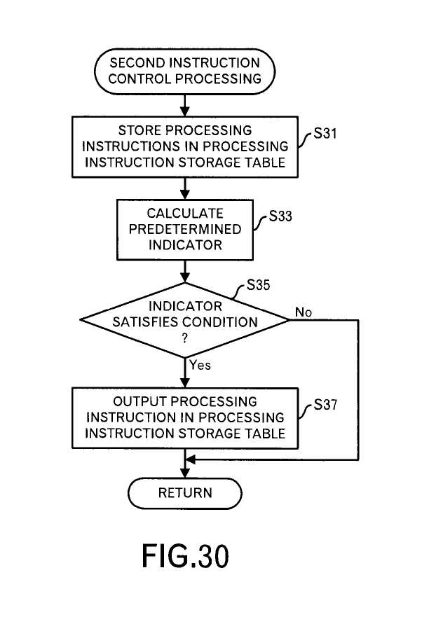

Next, processing contents of the instruction control processing will be explained by using FIG. 30. First, when receiving the processing instructions from the anonymizing processing unit 110, the data obtaining unit 121b stores the received processing instructions into the processing instruction storage table 131b (FIG. 30: step S31). In this embodiment, the end flag is not used. Therefore, the anonymizing processing unit 110 may not attaches the end flag. Then, the data obtaining unit 121b instructs the verification unit 123b to perform the processing.

The verification unit 123b calculates a predetermined indicator based on the processing instructions stored in the processing instruction storage table 131b in the data storage unit 130b (step S33). In this embodiment, for example, any one of three indicators is calculated.

In other words, any one of (A) the total number of processing instructions, (B) the number of processing instructions that is not related to the possibility that the individuals are identified (i.e. the processing instructions other than “recover” and “conceal”) and (C) a ratio of the total number of processing instructions to the number of processing instructions (“recover” or “conceal”) that relate to the probability that the individuals are identified (=a reciprocal of the ratio of the number of processing instructions that relate to the possibility that the individuals are identified to the total number of processing instructions) is employed.

This embodiment is based on a consideration that, when a certain number of processing instructions are executed, various processing variations are considered, so it is impossible to easily estimate. In case of (B), it is confirmed that a lot of processing instructions such as “conceal” and “recover” are not received. In addition, in case of (C), it is confirmed that a ratio of the processing instructions such as “conceal” and “recover” is less, and when the ratio of the processing instructions such as “conceal” and “recover” is less, the indicator (C) becomes greater.

Then, the verification unit 123b determines whether or not the indicator satisfies a condition stored in the definition data storage unit 140 (step S35). The condition is a threshold, for example, and a condition that the indicator is equal to or greater than the threshold “4” when the indicator is (A) or (B), or a condition that the indicator is equal to or greater than the threshold “4” when the indicator is (C) is employed. In case of the indicator (C), the condition represents that the processing instructions are obtained more than four times as much as the processing instructions such as “conceal” and “recover” are obtained.

These thresholds may be determined experimentally after verifying the possibility that the individuals are identified.

Then, when the indicator does not satisfy the condition, the processing ends. On the other hand, when the indicator satisfies the condition, the verification unit 123b instructs the output unit 124b to perform the processing. Then, the output unit 124b outputs the processing instructions stored in the processing instruction storage table 131b to the target systems 4 and 5 (step S37).

By carrying out such a processing, when some processing instructions are received, the processing instructions are outputted to the target systems 4 and 5. Therefore, the output frequency is lowered compared with a case of outputting the processing instructions each time when they are received, however, it is possible to suppress the possibility that the individuals are identified to a certain level without injuring the immediacy of the data updating so much.

### Embodiment 3

By combining the first embodiment and the second embodiment, it is possible to effectively suppress the possibility that the individuals are identified by the data analysis using the temporal difference while performing the data updating with a relatively high frequency.

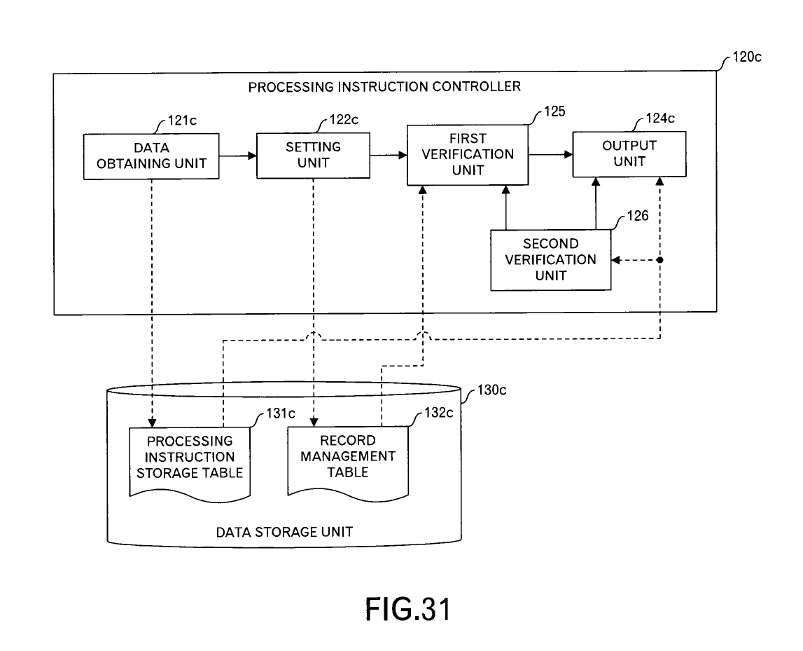

FIG. 31 illustrates a configuration example of a processing instruction controller 120c and data storage unit 130c, which relate to this embodiment. The processing instruction controller 120c has a data obtaining unit 121c, a setting unit 122c, a first verification unit 125, a second verification unit 126 and an output unit 124c. Moreover, the data storage unit 130c stores a processing instruction storage table 131c and a record management table 132c.

The first verification unit 125 performs a processing similar to that in the first embodiment. The second verification unit 126 performs a processing similar to that in the second embodiment.

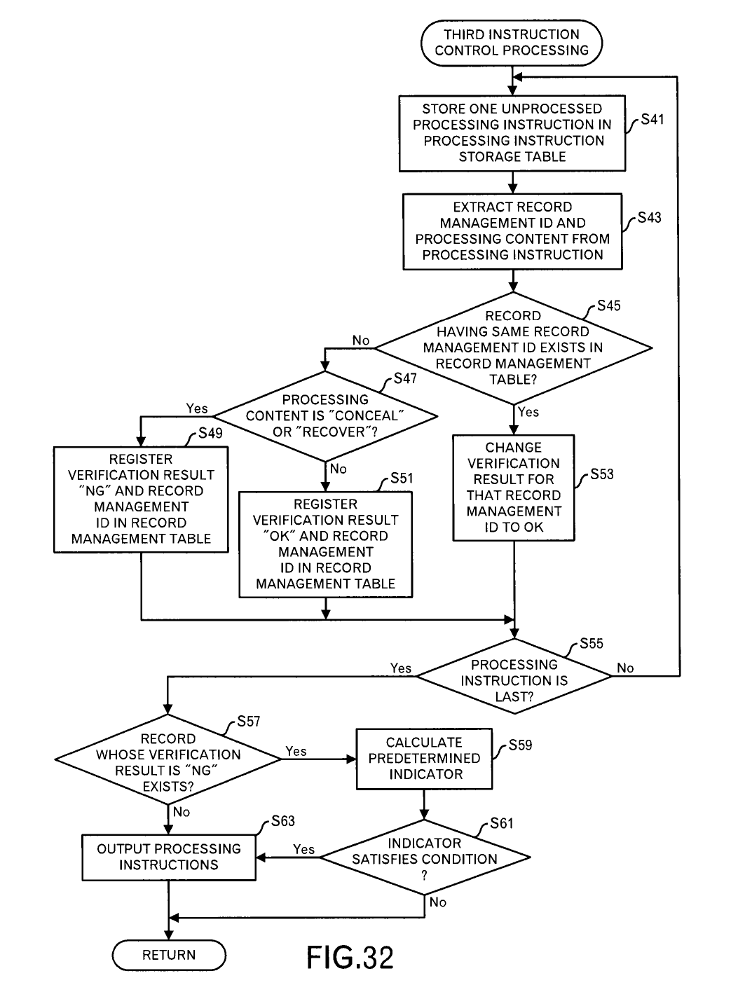

Next, processing contents of the processing instruction controller 120c will be explained by using FIG. 32.

The data obtaining unit 121c of the processing instruction controller 120c stores an unprocessed processing instruction among the processing instructions received from the anonymizing processing unit 110 into the processing instruction storage table 131c in the data storage unit 130c (FIG. 32: step S41). More specifically, the processing instruction is selected from the top in sequence. Moreover, the data obtaining unit 121c outputs the processing instruction to the setting unit 122c.

The setting unit 122c extracts the record management ID and processing content from the processing instruction (step S43), and determines whether or not a record having the same record management ID as the extracted record management ID has been registered in the record management table 132c in the data storage unit 130c (step S45). When the record is initially added, data having the same record management ID as the extracted record management ID has not been registered in the record management table 132c.

When the data having the same record management ID as the extracted record management ID has not been registered (step S45: No route), the setting unit 122c determines whether or not the extracted processing content is “conceal” or “recover” (step S47). When only these operations are performed, it has been understood that the possibility that the individuals are identified becomes high, when the temporal difference is calculated. Therefore, the extracted processing content is confirmed here. When the extracted processing content is “conceal” or “recover”, the setting unit 122c stores the verification result “NG” and the extracted record management ID in the record management table 132c (step S49). Then, the processing shifts to step S55. On the other hand, when the extracted processing content is not “conceal” or “recover”, the setting unit 122c stores the verification result “OK” and the extracted record management ID into the record management table 132c (step S51). Then, the processing shifts to the step S55.

On the other hand, when the data having the same record management ID as the extracted record management ID has been registered in the record management table 132c (step S45: Yes route), any one of three cases is applicable, namely, a first case where the “concealed” or “recovered” record is “updated” or “deleted”, a second case where the “concealed” record is “recovered”, or a third case where the “recovered” record is “concealed”. There is no problem for these cases even if the temporal difference is calculated. Therefore, the setting unit 122c changes the verification result of the extracted record management ID to “OK” in the record management table 132c (step S53). Then, the processing shifts to the step S55.

Then, the setting unit 122c determines whether or not the processing instruction is a final processing instruction among the obtained processing instructions, in other words, the end flag of the processing instruction being processed is “YES” (step S55). When the end flag of the processing instruction being processed is “NO”, the processing returns to the step S41.

On the other hand, when the end flag of the processing instruction being processed is “YES”, the setting unit 122c instructs the first verification unit 125 to perform the processing. The first verification unit 125 determines whether or not the record whose verification result is “NG” exists in the record management table 132c in the data storage unit 130c (step S57). In this embodiment, in order to avoid a problem that, unless the processing instruction is outputted again for the same record, the processing instructions including that processing instruction are not outputted indefinitely, the first verification unit 125 instructs the second verification unit 126 to perform the processing, when there is a record whose verification result is “NG”. The second verification unit 126 calculates a predetermined indicator based on the processing instructions stored in the processing instruction storage table 131c in the data storage unit 130c (step S59). In this embodiment, any one of the three indicators is calculated, for example, similarly to the second embodiment.

In other words, anyone of (A) the total number of processing instructions, (B) the number of processing instructions that is not related to the possibility that the individuals are identified (i.e. the processing instructions other than “recover” and “conceal”) and (C) a ratio of the total number of processing instructions to the number of processing instructions (“recover” or “conceal”) that relate to the probability that the individuals are identified (=a reciprocal of the ratio of the number of processing instructions that relate to the possibility that the individuals are identified to the total number of processing instructions) is employed.

Then, the second verification unit 126 determines whether or not the indicator satisfies a condition stored in the definition data storage unit 140 (step S61). The condition is a threshold, for example, and a condition that the indicator is equal to or greater than the threshold “4” when the indicator is (A) or (B), or a condition that the indicator is equal to or greater than the threshold “4” when the indicator is (C) is employed. In case of the indicator (C), the condition represents that the processing instructions are obtained more than four times as much as the processing instructions such as “conceal” and “recover” are obtained. These thresholds may be determined experimentally after verifying the possibility that the individuals are identified.

Then, when the indicator does not satisfy the condition, the processing ends. On the other hand, when the indicator satisfies the condition, the second verification unit 126 instructs the output unit 124c to perform the processing. Moreover, the second verification unit 126 clears the record management table 132c. Then, the output unit 124c outputs the processing instructions stored in the processing instruction storage table 131c to the target systems 4 and 5 (step S63).

On the other hand, when there is no record whose verification result is “NG”, the first verification unit 125 instructs the output unit 124c to perform the processing. Moreover, the verification unit 125 clears the record management table 132c. In other words, the processing shifts to the step S63.

The processing execution units 4b and 5b in the target systems 4 and 5 perform the processing instructions received from the information processing apparatus 100 in sequence for the DBs 4a and 5a.

By performing such a processing, it is possible to suppress the possibility that the individuals are identified, even when the data analysis by the temporal difference is performed, while securing the immediacy of the data updating in a certain level.

Although the embodiments of this invention were explained, the invention is not limited to the embodiments. For example, the functional block configurations of the aforementioned information processing apparatus 100 are mere examples, and may not correspond to the program module configuration. Furthermore, as for the processing flow, as long as the processing results do not change, the turns of steps may be exchanged or plural steps may be executed in parallel.

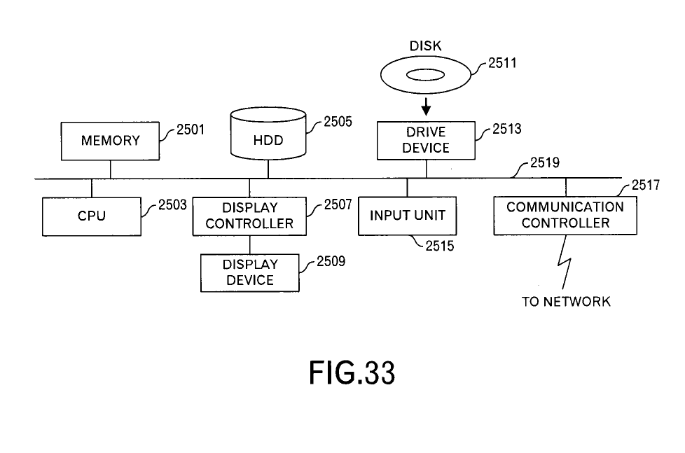

In addition, the aforementioned information processing apparatus 100, source systems 2 and 3, and target systems 4 and 5 are computer devices as illustrated in FIG. 33. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 33. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An information processing method relating to the embodiments includes: (A) receiving one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed; (B) determining whether or not processing instructions, which include the one or plural received processing instructions, before outputting satisfy a predetermined condition; (C) upon determining that the processing instructions before outputting satisfy the predetermined condition, outputting the processing instructions before outputting; and (D) upon determining that the processing instructions before outputting do not satisfy the predetermined condition, keeping the processing instructions before outputting.

This method stops outputting the processing instructions so as to sufficiently suppress the possibility that the individuals are identified.

The determining may include: determining whether or not the number of processing instructions before outputting, a reciprocal of a ratio of processing instructions that have a first kind of processing content to the number of processing instructions before outputting or the number of processing instructions that have a second kind of processing content, which is different from the first kind of processing content, among the processing instructions before outputting is equal to or greater than a threshold. By setting the threshold appropriately, it becomes possible to output the processing instructions without injuring the immediacy of the data updating.

The determining may include: determining whether a first condition that, in case where the processing instructions before outputting includes a first processing instruction that has a first kind of processing content, the processing instructions before outputting includes a second processing instruction that has a second kind of processing content, which is different from the first kind of processing content, for a data block that is the same as a data block for which the first processing instruction is to be performed, is satisfied or a second condition that the processing instructions before outputting do not include the first processing instruction is satisfied. By focusing on the first kind of processing content that affects to the possibility that the individuals are identified, it is possible to suppress the possibility that the individuals are identified, even when the data analysis using the temporal difference is performed.

Furthermore, the determining may further include: upon determining that the first and second conditions are not satisfied, determining whether or not the number of processing instructions before outputting, a reciprocal of a ratio of processing instructions that have the first kind of processing content to the number of processing instructions before outputting or the number of processing instructions that have the second kind of processing content among the processing instructions before outputting is equal to or greater than a threshold. Thus, it is possible to balance the immediacy of the data updating and the suppression of the possibility that the individuals are identified.

Furthermore, the first kind of processing content may include concealing parts of attribute values included in a certain data block and recovering an attribute value included in a certain data block. These processing contents affect the possibility that the individuals are identified. Therefore, the embodiments focus on these processing contents.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process comprising:
receiving one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed;
determining whether or not processing instructions, which include the one or plural received processing instructions, before outputting satisfy a predetermined condition;
upon determining that the processing instructions before outputting satisfy the predetermined condition, outputting the processing instructions before outputting; and
upon determining that the processing instructions before outputting do not satisfy the predetermined condition, keeping the processing instructions before outputting.

2. The computer-readable, non-transitory storage medium as set forth in claim 1, wherein the determining comprises:
determining whether or not the number of processing instructions before outputting, a reciprocal of a ratio of processing instructions that have a first kind of processing content to the number of processing instructions before outputting or the number of processing instructions that have a second kind of processing content, which is different from the first kind of processing content, among the processing instructions before outputting is equal to or greater than a threshold.

3. The computer-readable, non-transitory storage medium as set forth in claim 1, wherein the determining comprises:
determining whether a first condition that, in case where the processing instructions before outputting includes a first processing instruction that has a first kind of processing content, the processing instructions before outputting includes a second processing instruction that has a second kind of processing content, which is different from the first kind of processing content, for a data block that is the same as a data block for which the first processing instruction is to be performed, is satisfied or a second condition that the processing instructions before outputting do not include the first processing instruction is satisfied.

4. The computer-readable, non-transitory storage medium as set forth in claim 2, wherein the determining further comprises:
upon determining that the first and second conditions are not satisfied, determining whether or not the number of processing instructions before outputting, a reciprocal of a ratio of processing instructions that have the first kind of processing content to the number of processing instructions before outputting or the number of processing instructions that have the second kind of processing content among the processing instructions before outputting is equal to or greater than a threshold.

5. The computer-readable, non-transitory storage medium as set forth in claim 2, wherein the first kind of processing content includes concealing parts of attribute values included in a certain data block and recovering an attribute value included in a certain data block.

6. An information processing method comprising:
receiving, by using a computer, one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed;
determining, by using the computer, whether or not processing instructions, which include the one or plural received processing instructions, before outputting satisfy a predetermined condition;
upon determining that the processing instructions before outputting satisfy the predetermined condition, outputting, by using the computer, the processing instructions before outputting; and
upon determining that the processing instructions before outputting do not satisfy the predetermined condition, keeping, by using the computer, the processing instructions before outputting.

7. An information processing apparatus, comprising:
a memory; and
a processor configured to use the memory and execute a process comprising:
receiving one or plural processing instructions, each of which includes a result of an anonymizing processing, which is performed based on whether or not a plurality of data blocks that have a predetermined relationship exist, and a processing content to cause the result to be reflected, wherein each of the one or plural processing instructions is to be performed for a data block, for which the anonymizing processing has been performed;
determining whether or not processing instructions, which include the one or plural received processing instructions, before outputting satisfy a predetermined condition;
upon determining that the processing instructions before outputting satisfy the predetermined condition, outputting the processing instructions before outputting; and
upon determining that the processing instructions before outputting do not satisfy the predetermined condition, keeping the processing instructions before outputting.
